(19) United States
(12) Patent Application Publication
(10) Pub. No.: US 2012/0023133 A1
(43) Pub. Date: Jan. 26, 2012

(54) DOCUMENT SEARCHING SYSTEM AND METHOD

(75) Inventor: Chan Ik Yeon, Seongnam-si (KR)

(73) Assignee: WOODT INC., Seongnam-si (KR)

(21) Appl. No.: 13/262,469

(22) PCT Filed: Mar. 31, 2010
(86) PCT No.: PCT/KR2010/001991

§ 371 Date: Sep. 30, 2011

(30) Foreign Application Priority Data
Apr. 1, 2009 (KR) 10-2009-0028274
Mar. 31, 2010 (KR) 10-2010-0029463

(51) Int. Cl. G06F 17/30

(52) U.S. Cl. 707/770; 707/E17.008

(57) ABSTRACT

A document search system and a method are provided to enable a writer (document provider) of a document to detect metadata, which is included in web/WAP documents, and to offer summary or detailed information on the corresponding product (including multimedia content), which is indicated by the metadata, to a document reader. According to the present invention, a client detects the metadata inserted into the corresponding document from the document that is written by the document provider, extracts a reference value, demands production information corresponding to a product ID, to a serer to collect the product information and offers the product information to the document reader. Additionally, the client collects the reference value and information on the document reader who reads the document, into which the metadata is inserted, and stores the collected data in the server.

### TECHNICAL FIELD

The present invention relates to a document searching technology field, and more particularly to a document searching system and a method capable of providing multimedia services such as product purchase, play and the like to a document reader by detecting metadata included in WEB/WAP documents by a document writer and providing information on a corresponding product (including multimedia contents) indicated by the metadata to the documents reader.

### BACKGROUND ART

There are many documents on WEP/WAP. In order to provide a search system for the WEB/WAP documents, works for collecting and indexing the WEB/WAP documents should be carried out. For the indexing work, the WEB/WAP documents to be indexed are initially collected. A robot called as Spider or Crawler visits WEB/WAP pages and read out all of the contents therefrom. At this time, the robot sequentially visits another pages linked to the corresponding pages as well as the corresponding pages. Like this, the behavior visiting the WEB/WAP according to the links looks like a spider, so that the robot is called as Spider. Theses collected documents are processed and indexed to show the WEB/WAP documents in an appropriate order according to keywords.

In case of visiting a specific page on WEB/WAP, URL information of the corresponding page is only recorded. Thus, different WEB/WAP pages (e.g., page recording evaluation for a product A) managing the same products (including multimedia contents) are treated like that different products are read by document readers, although there are on not only different domains or networks but also identical networks or domains, and the document writers are identical and the respective documents treat the same subject (e.g., evaluation for a product A). Thus, if information on source URL, which the document readers have visited, is only recorded, it may be difficult to accurately measure an interest of the document readers for a specific product.

### DETAILED DESCRIPTION OF THE INVENTION

### Technical Problem

The present invention is to provide a document searching system and method capable of detecting metadata inserted into a WEB/WAP document by a writer of a document (document provider) and providing summary or detailed information of a corresponding product (including multimedia contents) indicated by the metadata to a document reader.

Further, the present invention is to provide a multimedia service such as purchase and play for a product provided to a document reader.

Further, the present invention is to collect information on products managed on a corresponding page instead of a WEB/WAP page itself, which a document reader has visited.

Further, the present invention is to provide record and statistics for products and contents, which a document reader has read.

### Technical Solution

According to one embodiment of the present invention, a document searching system and method capable of detecting metadata included in a WEB/WAP document by a writer of a document (document provider) and providing summary or detailed information of a corresponding product (including multimedia contents) indicated by the metadata to a document reader are disclosed. According to the present invention, a client detects metadata inserted into a document made by a document provider to extract a reference value, and collect information on a product based on the reference value of the metadata to provide to a document reader. And, the client collects information on the document reader who reads the document, in which the metadata is inserted, and the reference value to store in a server.

### Advantageous Effect

According to the present invention, there is a merit capable of providing a document searching system and method capable of detecting metadata included in a WEB/WAP document by a writer of a document (document provider) and providing summary or detailed information of a corresponding product (including multimedia contents) indicated by the metadata to a document reader. At this time, a purchase and a multimedia service such as a play for a product provided to the document reader are available.

Also, since the present invention collects information with respect to products managed on a corresponding page instead of a WEB/WAP page itself, which a document reader visits, there is a merit capable of accurately measure an interest of the document readers for a specific product.

Also, the present invention has a merit that products or contents, which the document reader has visited, may be provided.

### BRIEF DESCRIPTION OF DRAWINGS

FIG. 1 is a diagram showing a document searching system according to one embodiment of the present invention.

FIG. 2 is a diagram showing product information registered by an information provider according to one embodiment of the present invention.

FIG. 3 is a diagram showing metadata according to one embodiment of the present invention.

FIG. 4 is a diagram showing a HTML document included in metadata according to one embodiment of the present invention.

FIG. 5 is a diagram showing an example of information transferred from a metadata monitoring client to a metadata collecting client according to one embodiment of the present invention.

FIG. 6 is a diagram showing summary information of a product according to one embodiment of the present invention.

FIG. 7 is a diagram showing detailed information of a product according to one embodiment of the present invention.

FIG. 8 is a diagram showing product reading record information according one embodiment of the present invention.

FIG. 9 is a diagram showing an example of using a meta tag in a HTML document according to one embodiment of the present invention.

FIG. 10 is diagram showing an example of using a custom tag in a HTML document according to one embodiment of the present invention.

### BEST MODE

Hereinafter, embodiments of the present invention will be described in detail by referring to accompanying drawings. However, in case that the description may unnecessarily obscure the subject matter of the present invention, detailed description for well-known functions or elements will be omitted.

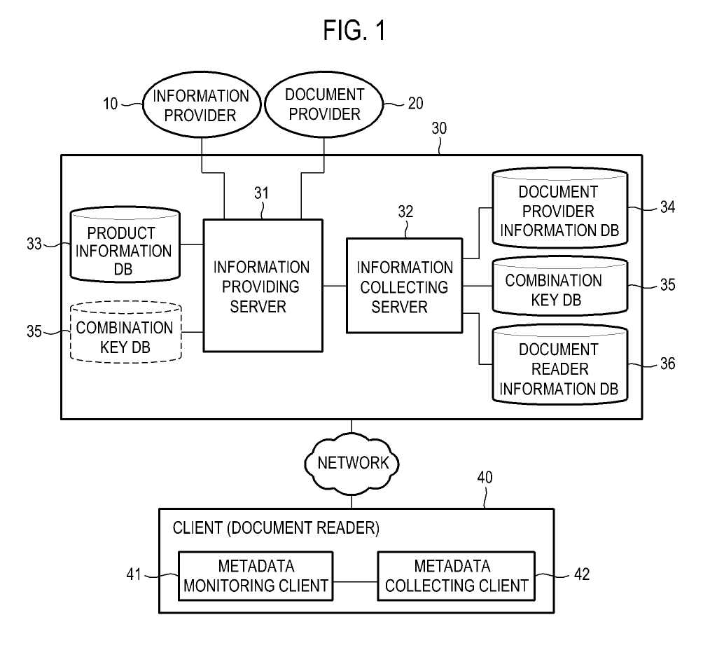

FIG. 1 is a block diagram showing an illustrative embodiment of a document search system.

The document search system according to the present invention includes an information provider 10, a document provider 20, a server 30 and a client 40 of a document reader. The server 30 includes an information providing server 31 and an information collecting server 32, and the client 40 of the document reader includes a metadata monitoring client 41 and a metadata collecting client 42. Although it may be configured to integrate the information providing server 31 and the information collecting server 32, it will be described that both servers 31 and 31 are separated in one embodiment. Also, the metadata monitoring client 41 and the metadata collecting client 42 may exist within one application. Further, although figures have been illustrated that a combination key DB 35 storing combination keys is installed on or interlocked with the information collecting server 32, the combination key DB 35 may be also installed on or interlocked with the information providing server 31.

More particularly, the document search system includes the client 40, which is configured to detect metadata inserted into a document written by the document provider 20 to extract a reference value thereof and collect information of a corresponding product based on the reference value of the metadata to provide it for the document reader, and the information providing server 31 including or interlocked with the product information DB 33 storing information on products classified with product IDs and providing product information corresponding to a product ID indicated by the reference value to the metadata collecting client 42. Also, the document search system further includes the information collecting server 32 configured to collect information of a document reader who reads a document in which the metadata are inserted and the reference value for storage to the document reader information DB 36.

The client 40 includes the metadata monitoring client 41, which is configured to detect metadata inserted into a document written by the document provider 20 to extract a reference value thereof and the metadata collecting client 42, which is configured to collect information of a corresponding product based on the metadata reference value extracted in the metadata monitoring client 41 to provide it for the document reader.

Also, the metadata monitoring client 41 may perform a function of extracting a reference value of metadata and a function of collecting information of products to provide it for a document reader.

The reference value may be one of a product ID (first embodiment) and a combination key mapped with a product ID and a document provider ID (second embodiment). In such a case, the combination key includes the product ID and may be information on any one, some, or entire combination selected from a group constituted by at least one among information on the document provider ID and a part of metadata (e.g., title, notice window title, information indicative of whether preview is played, seller information, etc.)

Also, although the product ID is actually “0001,” it may be represented as URL such as “http://example.com/0001” when the product ID is written in the metadata. That is, the reference value, which is an information reference indicating product information (summary information, detailed information, etc.) for an arbitrary product, may be variously modified. Also, the document is a document, which is published on Internet by inserting metadata created based on a reference value for a specific product by searching for a product registered by a document provider 20, and the document may be a postscript document for a product including multimedia contents.

The product information DB 33 is configured to store product titles, URL, product IDs, summary information and detailed information of the products, images and the like. The document provider information DB 34 is configured to basic information such as ID, name, age, sex, etc. of a user producing the product. The combination key DB 35 is configured to store a combination key capable of recognizing a product ID and a product provider 20. The document reader information DB 36 is configured to store basic information such as id, name, age, sex of a document reader, a reference value, summary information and a document reading time of the read document and a source URL of the document.

In case that the reference value is the product id, the embodiment may be variously implemented according to the path transferring the product information as follows. The following embodiments 1-1 to 1-4 are cases which the producer DB 33 is included or interlocked in or with the information providing server 31.

According to the 1-1 embodiment, the information providing server 31 is configured to search the product information DB 33 for the product information corresponding to a product ID indicated by a reference value (product ID) of metadata, which are transferred from the metadata collecting client 42 (/metadata monitoring client 41) to provide to the metadata collecting client 42 (/metadata monitoring client 41).

According to the 1-2 embodiment, the information providing server 31 is configured to search the product information DB 33 for the product information corresponding to a product ID indicated by a reference value (product ID) of metadata, which are transferred from the metadata collecting client 42 (/metadata monitoring client 41) to provide to the information collecting server 32. Thereafter, the information collecting server 32 is configured to provider the corresponding product information to the metadata collecting client 42 (/metadata monitoring client 41).

According to the 1-3 embodiment, the information collecting server 32 is configured to transfer a reference value (product ID) of metadata, which are transferred from the metadata collecting client 42 (/metadata monitoring client 41) to the information providing server 31, and the information providing server 31 is configured to search the product information DB 33 for the product information corresponding to a product ID indicated by the reference value (product ID) of metadata to provide to the metadata collecting client 42 (/metadata monitoring client 41).

According to the 1-4 embodiment, the information collecting server 32 is configured to transfer a reference value (product ID), which is transferred from the metadata collecting client 42 (/metadata monitoring client 41) to the information providing server 31, and the information providing server 31 is configured to search the product information DB 33 for the product information corresponding to a product ID indicated by the reference value (product ID) of metadata to provide to the information collecting server 32. Thereafter, the information collecting server 32 is configured to provide the product information, which is transferred from the information providing server 31, to the metadata collecting client 42 (/metadata monitoring client 41).

In case of using the combination key as the reference value according to the second embodiment, it may be differently implemented such as the following 2-1 embodiment and 2-2 embodiment according to the location in which the combination key DB storing the combination key is established. The following 2-1-1 to 2-1-4 embodiments are cases which the combination key DB 35 is included/interlocked in/with the information providing server 31. Also, the following 2-2-1 to 2-2-4 embodiments are cases which the combination key DB 35 is included/interlocked in/with the information collecting server 32.

According to the 2-1-1 embodiment, the metadata collecting client 42 (/metadata monitoring client 41) is configured to transfer the reference value (combination key) to the information providing server 31. Thereafter, the information providing server 31 is configured to search the combination key DB 35 for a product ID corresponding to the combination key and search the product information DB 33 for product information corresponding to the product ID to provide to the metadata collecting client 42 (/metadata monitoring client 41).

According to the 2-1-2 embodiment, the metadata collecting client 42(/metadata monitoring client 41) is configured to transfer a reference value (combination key) to the information providing server 31. Thereafter, the information providing server 31 is configured to search the combination key DB 35 for a product ID corresponding to the combination key and search the product information DB 33 for product information corresponding to the product ID to transfer to the information collecting server 32. Next, the information collecting server 32 is configured to provide the corresponding product information to the metadata collecting client 42 (/metadata monitoring client 41).

According to the 2-1-3 embodiment, the metadata collecting client 42 (/metadata monitoring client 41) is configured to transfer a reference value (combination key) to the information collecting server 32. Thereafter, the information collecting server 32 is configured to transfer the reference value (combination key) of the metadata, which is transferred from the metadata collecting client 42 (/metadata client 41), to the information providing server 31, and the information providing server 31 is configured to search the combination key DB 35 for a product ID corresponding to the combination key and search the product information DB 33 for the product information corresponding to the product ID to provide to the metadata collecting client 42 (/metadata monitoring client 41).

According to the 2-1-4 embodiment, the metadata collecting client 42 (/metadata monitoring client 41) is configured to transfer a reference value (combination key) to the information collecting server 32. Thereafter, the information collecting server 32 is configured to transfer the reference value (combination key) of the metadata, which is transferred from the metadata collecting client 42 (/metadata monitoring client 41) to the information providing server 31, and the information providing server 31 is configured to search the combination key DB 35 for the product ID corresponding to the combination key and search the product information DB 33 for the product information corresponding to the product ID to provide to the information collecting server 32. Thereafter, the information collecting server 32 is configured to provide the product information transferred from the information providing server 31 to the metadata collecting client 42 (/metadata monitoring client 41).

In the meantime, according to the 2-2-1 embodiment, the metadata collecting client 42 (/metadata monitoring client 41) is configured to transfer a reference value (combination key) to the information collecting server 32. Thereafter, the information collecting server 32 is configured to search the combination DB 35 for a product ID corresponding to the combination key based on the reference value (combination key) of the metadata, which is transferred from the metadata collecting client 42 (/metadata monitoring client 41) to provide to the metadata collecting client 42 (/metadata monitoring client 41). Thereafter, the metadata collecting client 42 (/metadata monitoring client 41) is configured to directly request product information corresponding to the product ID, which is transferred from the information collecting server 32, to the information providing server 31, and the information providing server 31 is configured to search the product information DB 33 for the product information corresponding to the product ID to transfer to the metadata collecting client 42 (/metadata monitoring client 41).

According to the 2-2-2 embodiment, the metadata collecting client 42 (/metadata monitoring client 41) is configured to transfer a reference value (combination key) to the information collecting server 32. Thereafter, the information collecting server 32 is configured to search the combination DB 35 for a product ID corresponding to the combination key based on the reference value (combination key) of the metadata, which is transferred from the metadata collecting client 42 (/metadata monitoring client 41) to request the product information corresponding to the product ID to the information providing server 31, and the information providing server 31 is configured to search the product information DB 33 for the product information corresponding to the product ID to transfer to the information collecting server 32. Thereafter, the information collecting server 32 is configured to transfer the product information transferred from the information providing server 31 to the metadata collecting client 42 (/metadata monitoring client 41).

According to the 2-2-3 embodiment, the metadata collecting client 42 (/metadata monitoring client 41) is configured to transfer a reference value (combination key) to the information collecting server 32. Thereafter, the information collecting server 32 is configured to search the combination key DB 35 for a product ID corresponding to the combination key based on a reference value (combination key) of the metadata, which is transferred from the metadata collecting client 42 (/metadata monitoring client 41) and request product information corresponding to the product ID to the information providing server. The information providing server 31 is configured to search the product information DB 33 for the product information corresponding to the product ID to transfer to the metadata collecting client 42 (/metadata monitoring client 41).

According to the 2-2-4 embodiment, the metadata collecting client 42 (/metadata monitoring client 41) is configured to transfer the reference value (combination key) to the information providing server 31. Thereafter, the information providing server 31 is configured to transfer the reference value (combination key) to the information collecting server 32, receive a product ID corresponding to the combination key, which is searched based on the combination key DB 35, from the information collecting server 32, and find product information corresponding to the product ID from the product information DB 33 to transfer to the metadata collecting client 42 (/metadata monitoring client 41).

In the above, the product information includes summary information or detailed information on the product, and the purchase or replay of the corresponding product is possible while the document reader reads the product information.

Also, the metadata monitoring client 41 is configured to notify the detection of the metadata to a document reader with one of a notifice window and a sound or the combination thereof. Also, the metadata monitoring client 41 may be installed on a terminal of the document reader or automatically executed by a browser with being inserted into the document.

In such a case, if the metadata of the document is included in a tag for executing the metadata monitoring client (e.g., DeepBrowser.swf), the browser detects the tag and automatically executes the metadata monitoring client 41 indicated in the tag. Thereafter, the metadata monitoring client 41 is configured to extract the reference value of the metadata included in the document.

Also, the metadata collecting client 42 is configured to receive from the information collecting server 32 one, a part or entire combination information selected from the group consisting of a reference value of the corresponding document reader, URL information on the document provider and document reading time information to provide to the document reader.

The metadata includes at least one of summary information of the product defined in the document read by the document reader and a reference value to be taken from the information providing server 31.

In the meantime, when the metadata is detected, the metadata may include all of information to be notified to the document reader (e.g., product image, URL link, title, etc.) according to the third embodiment. In case that the URL link of the summary/detailed information is provided in the metadata, the document reader may read the summary and/or detailed information of the corresponding product through the linked URL. In such a case, the functions of the metadata monitoring client 41 and the metadata collecting client 42 may be implemented through a plug-in of a viewer or by being integrated with their functions, or only the metadata collecting client 42 may be embodied with an additional external application. Therefore, the metadata monitoring client 41 or the metadata collecting client 42 can provide the product information to the document reader even if the summary and/or detailed information of the product is not received from the information providing server 31.

According to the first to third embodiments, it may occur that the metadata collecting client 42 is not installed or executed. In such a case, the metadata reference value is transferred to the information collecting server 32 and, after the metadata collecting client is installed and executed, the information on the products, which are read all the while, is transferred to the metadata collecting client 42. In this time, the metadata collecting client 42 and the information collecting server 32 may be connected with a network (e.g., Socket). Also, the connection may be achieved in a Request/Response way (Polling/Pulling). In such a case, the metadata collecting client 42 is configured to periodically access the information collecting server 32 to identify whether the metadata is newly detected.

In the meantime, according to the fourth embodiment of the present invention, the monitoring client 41 may be configured to detect the metadata inserted into the corresponding document, which is made out by the document provider, extract a reference value (product ID or combination key) and request product information corresponding to a product ID indicated by the reference value for reception. This is that the product information requesting function of the metadata collecting client 42 in the first and second embodiments is carried out by the metadata monitoring client 41. The ways of requesting and transferring the product information are identical to each other.

In the first to fourth embodiments, when the fact detecting the metadata is recorded in the information collecting server 32, not only the metadata collecting client 42 but also the metadata monitoring client 41 may become a main element. Also, it may be embodied that a function of notifying the fact detecting the metadata to the document reader is not included.

In one embodiment, in case of receiving the product information via the information collecting server 32, a reading fact at a time of passing the information collecting server 32 may be recorded. In case of not passing the information collecting server 32, a record of reading facts may be request to the information collecting server 32 during a procedure that the information providing server 31 searches the product information.

### [Aspects for Performing the Invention]

Hereinafter, a procedure that the document provider 20 registers a document including evaluation on a specific product P on his/her blog and a document reader visits the blog of the document provider 20 and read the corresponding document will be described according to the first and second embodiments.

[Information Providing Step]

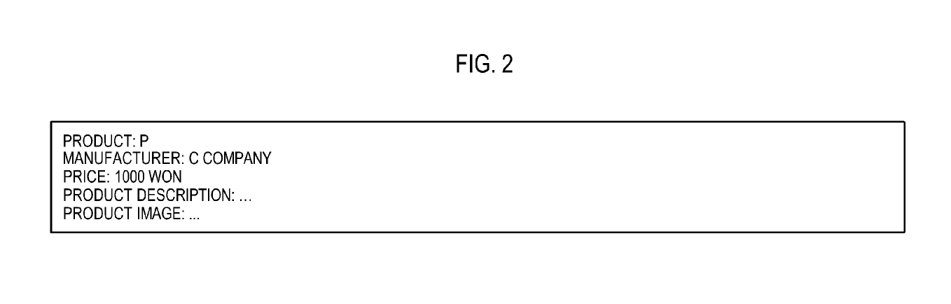

A specific company or person, which is an information provider 10, stores (registers) information on a product P of his company/other company or himself/others in the information providing server 31. For example, as illustrated in FIG. 2, the information provider 10 (e.g., C company) creates “0001” as a product ID value for a product P and stores it together with product information (summary information, detailed information, etc.) in the product information DB 33.

In one embodiment, the information provider 10 registers information on a product or general knowledge in an input window through software for an information provider or a WEB/WAP page. In another embodiment, external information may be brought or referenced by using Web Service API (e.g., Open API) (e.g., Affiliate Program of Amazon, Wikipedia, etc.).

[Document Writing and Distributing Step]

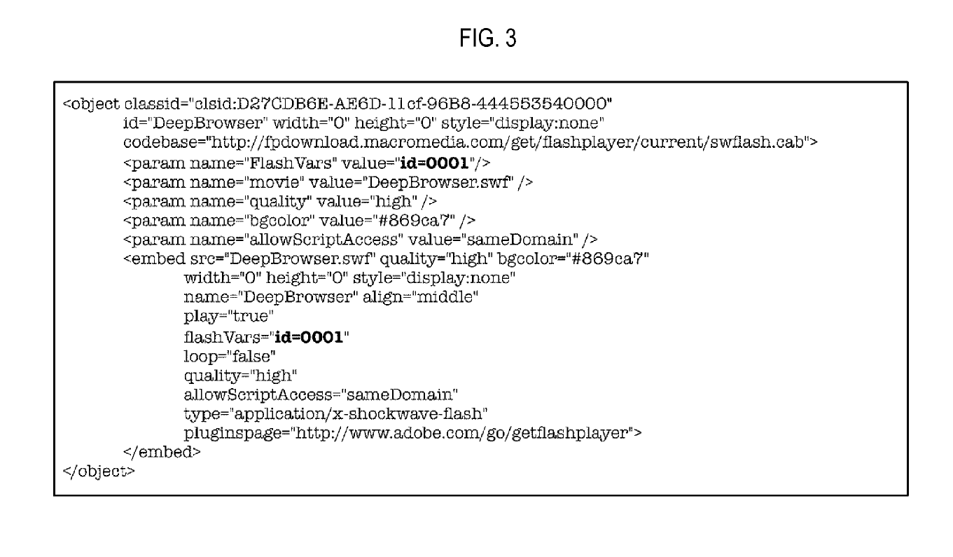

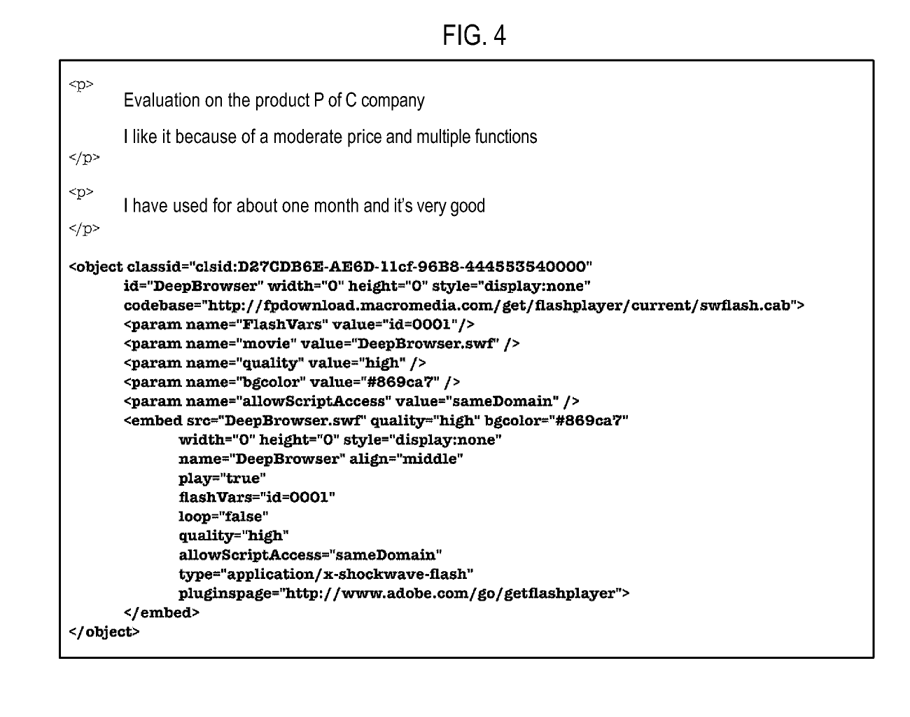

A blogger, which is the document provider 20, searches the product P desired to leave his evaluation by referring to the product information DB 33 in the information providing server 31 to create metadata, as shown in FIG. 3 and inserts the metadata into an evaluation HTML document, which is written by himself, as shown in FIG. 4, to upload to his blog.

In one embodiment, the metadata may be one, a part or entire combination information selected from the group consisting of a product ID, a URL source, a title, summary information, etc. The document provider 20 makes the metadata included in the document in writing the document. For example, the metadata may be an element of XML, a tag of XHTML/HTML or an internal usage format of a binary type in case of PDF, DOC and HWP documents. Also, the metadata may be a Plugin/ActiveX (e.g., Adobe Flash/Flex, JavaFX, Silverlight, etc.) based script or a program form. Further, the metadata can be included in multimedia of a moving image, an image and the like in addition to the document. The metadata may exist in a Tag/Script type of a non-visual type, however, the metadata may exist in a visual type such as an icon, a button and the like (e.g., Flash button including the metadata).

In FIG. 3, “DeepBrowser.swf”, which is the metadata monitoring client 41, is executed by a browser is a Flash application, which functions to transfer a reference value (e.g., product ID value “0001”) and a source URL of the corresponding document by using a LocalConnection object to the metadata collecting client (e.g., developed as Adobe AIR) 42.

The document provider 20 may search products existing in the product information DB 33 of the information providing server 31 through an additional Web/Wap page or software for a document provider. Also, these functions may be provided in a document editor provided in a blog service. For example, if the document provider 20 input a key word (e.g., camera) on a search word input window, then a product list suitable for the corresponding key word is displayed and the document provider 20 selects a product desired to be attached in the document among the product list. If there is only one as a search result suitable for the inputted key word, a process for selecting the product may be omitted.

If the document provider 20 selects the product, metadata will be created through the following process.

First, according to the first embodiment, it is a case that the document provider 20 does not have to additionally create a reference value (product ID) for the product. That is, if the document provider 20 selects one from the searched product list, then the document providing server 31 is configured to display a reference value (product ID) for the corresponding product on a screen and the document provider 20 creates metadata based on the reference value (product ID) displayed on the screen.

Second, according to the second embodiment, it is a case that the document provider 20 additionally creates a reference value (combination key) for the product in the information providing server 31 or the information collecting server 32. That is, if the document provider 20 selects one from the searched product list, then the information providing server 31 is configured to check whether to create a reference value for the corresponding product (or automatically create without the checking step) and create the reference value for the corresponding product. If an identical reference value already exists, the identification step may be omitted. Also, even if an identical reference value already exists, additional creation may be possible. The information providing server 31 is configured to display the currently created reference value (or previously created reference value) on a screen of the document provider 20 and the document provider 20 creates metadata based on the reference value displayed on the screen.

Third, it is a case that all of the first and second methods are provided. That is, if the document provider 20 selects one from the searched product list, then the information providing server 31 checks whether to create the reference value. In such a case, the information providing server 31 is configured to display the reference value on a screen of the document provider 20 according to the first method when the document provider does not want to create the reference value or according to the second method when the document provider wants to create the reference value. The document provider 20 creates metadata based on the reference value (product ID or combination key) displayed on the screen.

In the second method, when the combination key is used as the reference value, it may be possible not to include information of the document provider 20 in the combination key. This case is that allows a value, which does not refer to the document provider information DB 34, as the combination key. For example, the combination key “0001” represents a product A. However, a combination key “0002” containing the information of the document provider represents a product A and the document provider 20 at the same time.

In one embodiment, the document provider 20 may directly make out the metadata by referring to the reference value for the product displayed on the result screen and help (manual necessary for creating the metadata).

In another embodiment, the pre-created metadata may be formatted in a format to be attached (herein, HTML) like a multimedia service such as YouTube and the like for display. Also, a function of copying the metadata in a clipboard is provided such that the document provider 20 can directly make out the metadata. Further, other metadata except for the reference value are inputted, displayed and copied in the clipboard such that the document provider 20 can directly make out the metadata.

According to further another embodiment, in case of using an on-line document editor provided in a blog service or software for document edition, a function of attaching the metadata to a currently created document (evaluation) right away may be provided. At this time, a reference value for a product searched or created in an additional web page or by software for a document provider is inputted in a format of an input window. Also, in case that search and creation functions are included in the document editor provided in the blog service, the reference value is directly searched and created in the corresponding function of the document editor and the reference value of the product is included in the metadata. Further, metadata values desired to additionally add are added in a format of the input window. The inputted metadata are automatically attached to the corresponding document (evaluation).

In one embodiment, when the document provider 20 insert the written metadata into the document, a function such as “edit to HTML” among the functions of the editor of the blog service is used for insertion. In another embodiment, in case of a blog service providing a posting function through document file upload, the metadata is made by using a document editor installed on a computer of the document provider 20, or by inputting HTML with text in case of HTML, or the metadata is attached in the document by providing a plug-in at a document editing software capable of editing the corresponding document in case of uploading a document except for HTML. Also, the metadata may be attached by displaying an input window allowing user to input the metadata in uploading a file.

All of other values except for the reference value for the product among the metadata values may be arbitrarily created by the document provider 20 and do not have to be coincided with the product information registered in the information providing server 31. For example, assuming that there is information indicating “title to be displayed on notice window” among the metadata, even if its basic value is stored as “Product A” in the information providing server 31, the document provider 20 can attach the metadata recited as “Product A” to the document.

Document of any contents desired by the document provider 20 are possible as the document in which the metadata is inserted. For example, image or moving image of the product may be uploaded together and a link capable of downloading the clients 41 and 42, an image and an advice text may be provided for the document reader on which the metadata monitoring client 41 and the metadata collecting client 42 are not installed.

Herein, in case that the metadata monitoring client 41 and the metadata collecting client 42 are installed on a computer of the document reader, it is general that a warning message such as “install plug-in” may be displayed, or an icon notifying that “corresponding contents cannot be display” on a position of a corresponding object/embed tag is displayed. In such a case, if this link, image or information text is inserted in the object/embed tag, the corresponding link, image and information text may be displayed without displaying the warning message or the icon.

In registering the document, only contents and metadata, which are written by the document provider 20, are included, however, it is not necessary to show the document registered by the document provider 20 to the document reader identically. That is, when the document reader reads the document, the document may be displayed with a blog menu and various scripts and tags for implementing blog functions such as a category link, a comment, a comment input window, hits, modification/elimination button and the like.

The document provider 20 may distribute (post) the document written by him/her on Internet in various types. Generally, it means all of ways registering the documents to the blog. For example, the written document file may be uploaded, the document may be registered through an online document editor or software for document edition, which are provided in the blog, or the document may be registered through application for document registration, which is provided in the blog.

[Document Reading Step]

The document reader logs in by executing the metadata collecting client 42. Also, the metadata collecting client may be executed during monitoring the metadata in the metadata monitoring client 41. Also, it may be requested whether to execute or checked whether to install when the metadata collecting client 42 is not installed.

The metadata collecting client 42 checks a previously designated specific LocalConnection channel from start to end. The document reader performs WEB/WAP surfing by using a browser while the metadata collecting client 42 operates and reads a document (evaluation) for a product P, which is written by the document provider 20. In this time, the browser enable to automatically execute the metadata monitoring client DeepBrower.swf included in the document through the previously installed plug-in and the metadata monitoring client DeepBrowser.swf extracts a reference value in the metadata to transfer to the metadata collecting client 42.

Herein, the browser function of detecting the metadata and a function of the metadata monitoring client DeepBrowser.swf for extracting the reference value may be carried out by the metadata monitoring client 41, which is previously installed on the computer of the document reader. In one embodiment, the metadata monitoring client 41 represents that the metadata monitoring client DeepBrowser.swf is automatically executed by previously installing the metadata on the computer of the document reader or by installing and activating a Flash Player such that the metadata monitoring client DeepBrowser.swf included in the metadata of the document on a browser of the document reader. Also, the function of the metadata monitoring client 41 may be controlled through an activation/inactivation function of the metadata monitoring client in a setup page for the document reader. The metadata monitoring client 41 is activated/inactivated according to an activation/inactivation setup value.

In case that the document reader reads the document written by the document provider 20, not only the evaluation but also metadata contents can be shown together. For example, a meta tag or contents of the metadata are displayed on one side of the browser, or a function of displaying with an addition notice window may be provided. That is, it may be set to be automatically displayed in the browser itself, or the contents of the metadata or some information indicated by the metadata may be displayed instead of a button or an icon by applying a method of displaying visual information of a button or an icon.

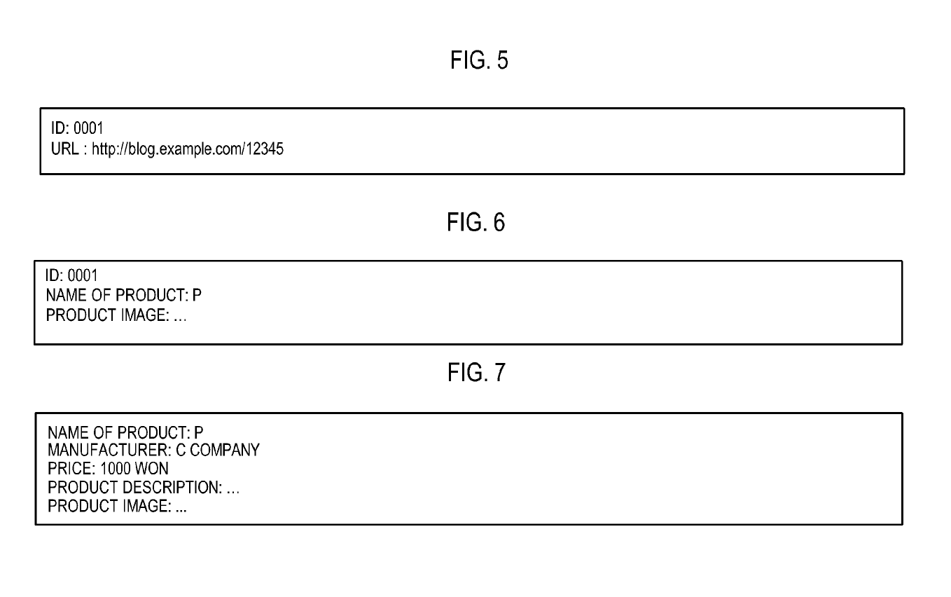

The metadata monitoring client (DeepBrowser.swf) 41 brings a reference value “0001” from the metadata at the same time with execution thereof, and also brings a URL of a current page of the document provider 20, i.e., a source URL to transfer to the metadata collecting client 42 through a previously designated specific LocalConnection channel. That is, the metadata monitoring client 41 transfers the reference value and the source URL information, as shown in FIG. 5, to the metadata collecting client 42 through the LocalConnection channel. Of course, in case that other information (e.g., document provider ID, notice window title, etc.) except for the reference value in the metadata exists, the corresponding information is also transferred to the metadata collecting client 42. Also, in case that the metadata monitoring client becomes a main element for requesting product information and the metadata collecting client 42 becomes a main element for receiving the result, there is a messaging method for transferring this information in response to each request in addition to the LocalConnection between the metadata monitoring client 41 and the metadata collecting client 42 without connection such as Socket and the like. The LocalConnection may be replaced by using communication methods between applications such as Socket, API or I/O channel, which messaging is possible between applications, a method of reading/writing data at a specific location of a previously agreed memory and the like.

Herein, a pluin or add-on of the browser by be utilized as the source URL information (JavaScript accessing function) or the source URL information may be directly specified in the metadata of the document by the document provider 20. The metadata monitoring client 41 detects the source URL to transfer to the metadata collecting client 42 together with the reference value. The metadata collecting client 42 transfers the reference value and the source URL information to the information collecting server 32.

[Product Information Collecting Step]

The metadata collecting client 42 receives the reference value and the source URL of the product P through a specific LocalConnection channel from the metadata monitoring client 41.

The metadata collecting client 42 (or metadata monitoring client 41) requests summary information or detailed information of a product corresponding to the reference value (product ID or combination key) to the information providing server 31 directly or via the information collecting server 32. The information providing server 31 transfer the product information, as shown in FIG. 6, to the metadata collecting client 42(/metadata monitoring client 41) directly or via the information collecting server 32 in response to the request. At this time, methods of requesting and transferring the product information may exist in various types as follows.

According to the 1-1 embodiment, if the client 42 or 41 transfers a reference value (product ID) of the metadata included in the document to the information providing server 31, then the information providing server 31 searches from a product information DB 33 product information corresponding to a product ID indicated by the reference value to provide to the client 42 or 42.

According to the 1-2 embodiment, if the client 42 or 41 transfers a reference value (product

ID) of the metadata included in the document to the information providing server 31, then the information providing server 31 searches from a product information DB 33 product information corresponding to a product ID indicated by the reference value to provide to the information collecting server 32 and the information collecting server 32 provides the corresponding product information to the client 42 or 42.

According to 1-3 embodiment, if the client 42 or 41 transfers a reference value (product ID) of the metadata included in the document to the information collecting server 32, then the information collecting server 32 searches from a product information DB 33 product information corresponding to a product ID indicated by the reference value to provide to the client 42 or 42.

According to 1-4 embodiment, if the client 42 or 41 transfers a reference value (product ID) of the metadata included in the document to the information collecting server 32, then the information collecting server 32 transfers the reference value of the metadata to the information providing server 31, the information providing server 31 searches from a product information DB 33 product information corresponding to a product ID indicated by the reference value to transfer to the information collecting server 32. The information collecting server 32 provides the product information transferred form the information providing server 31 to the client 42 or 42.

According to the 2-1-1 embodiment, if the client 42 or 41 transfers a reference value (combination key) to the information providing server 31, then the information providing server 31 searches from a combination key DB 35 a product ID corresponding to the combination key and searches from a product information DB 33 product information corresponding to the product ID to provide to the client 42 or 42.

According to the 2-1-2 embodiment, if the client 42 or 41 transfers a reference value (combination key) to the information providing server 31, then the information providing server 31 searches from a combination key DB 35 a product ID corresponding to the combination key and searches from a product information DB 33 product information corresponding to the product ID to provide to the information collecting server 32, and the information collecting server 32 transfers the corresponding product information to the client 42 or 42.

According to the 2-1-3 embodiment, if the client 42 or 41 transfers a reference value (combination key) to the information collecting server 32, then the information collecting server 32 transfers the reference value of the metadata to the information providing server 31, the information providing server 31 searches from a combination key DB 35 a product ID corresponding to the combination key and searches from a product information DB 33 product information corresponding to the product ID to provide to the client 42 or 42.

According to the 2-1-4 embodiment, if the client 42 or 41 transfers a reference value (combination key) to the information collecting server 32, then the information collecting server 32 transfers the reference value of the metadata to the information providing server 31, the information providing server 31 searches from a combination key DB 35 a product ID corresponding to the combination key and searches from a product information DB 33 product information corresponding to the product ID to provide to the information collecting server 32, and the information collecting server 32 provides the product information transferred from the information providing server 31 to the client 42 or 42.

According to the 2-2-1 embodiment, if the client 42 or 41 transfers a reference value (combination key) to the information collecting server 32, then the information collecting server 32 searches from the combination key DB 35 a product ID corresponding to the combination key based on the reference value of the metadata to transfer to the client 42 or 41. The client 42 or 41 directly requests product information corresponding to the product ID transferred from the information collecting server 32 to the information providing server 31, and the information providing server 31 searches from the product information DB 33 the product information corresponding to the product ID to transfer to the client 42 or

According to the 2-2-2 embodiment, if the client 42 or 42 transfers a reference value (combination key) to the information collecting server 32, then the information collecting server 32 searches from the combination key DB 35 a product ID corresponding to the combination key based on the reference value of the metadata and requests product information corresponding to the product ID to the information providing server 31, and the information providing server 31 searches the product information corresponding to the product ID from the product information DB 33 to transfer to the information collecting server 32. The information collecting server 32 transfers the product information transferred from the information providing server 31 to the client 42 or 41.

According to the 2-2-3 embodiment, if the client 42 or 41 transfers a reference value (combination key) to the information collecting serve 32, then the information collecting server 32 searches from the combination key DB 35 a product ID corresponding to the combination key based on the reference value of the metadata and requests product information corresponding to the product ID to the information providing server 31, and the information providing server 31 searches from the product information DB 33 the product information corresponding to the product ID to transfer to the client 42 or 41.

According to the 2-2-4 embodiment, if the client 42 or 41 transfers a reference value (combination key) to the information providing server 31, then the information providing server 31 transfers the reference value (combination key) to the information collecting sever 32 and the information collecting sever 32 receives a product ID corresponding to the combination key, which is searched based on the combination key DB 35 and searches from the product information DB 33 the product information corresponding to the product ID to transfer to the client 42 or 41.

In the above, after the summary information for the product is provided through the notice window and the like, the detailed information of the product may be provided to the information providing server 31 through the same processing procedure as the first and second embodiments in response to the request of the document reader (click event). However, although the procedure of providing the summary information to the document reader is not preceded, the detailed information may immediately provided.

The metadata collecting client 42 (/metadata monitoring client 41) is configured to receive product information (herein, assumed as summary information of the product) as shown in FIG. 6 to display a notice window message such as “There is information on a product P on the current page” together with a product image (Thumbnail) on a screen (e.g., right and lower side of the screen) of the document reader. At this time, alarm may be outputted together

Also, the metadata collecting client 42 (/metadata monitoring client 41) notifies information on the document reader (document reader ID), some information on the metadata of the product P (e.g., reference value), a source URL, reading time information and the like to the information collecting server 32. The information collecting server 32 stores information on documents reading of the document reader (document reader information, reference value, source URL, reading time information, etc.) in a document reader information DB 36. This transferred information is used for record reading, statistics, trend check and the like in the future.

[Product Information Reading and Purchasing and Playing Step]

If the document reader clicks the notice window about product information (summary information of the product), then the metadata collecting client 42 (/metadata monitoring client 41) requests and receives the detailed information of the corresponding product, as shown in FIG. 7, in the same manner with a process of requesting and transferring the summary information to show to the document reader. At this time, the document reader is able to not only check the detailed information of the product but also purchase the product immediately. For example, if the document reader clicks a “Purchase” button on a detailed information screen of the product for purchase, then the metadata collecting client 43 (/metadata monitoring client 41) provides a settlement screen such that the document reader can purchase the product. In the meantime, in case of movie or music, the metadata collecting client 42 (/metadata monitoring client 41) plays the corresponding product immediately or provide an environment capable of operating Preview, Trailer, etc.

More particularly, the product registered in the information providing server 31 is configured to include a link of a media file such as movie, music, Preview and trailer of the movie or music. Thus, when the metadata collecting client 42 (/metadata monitoring client 41) brings product information from the information providing server 31, if the link of the media file exists, the medial file may be immediately played. In addition, if the media file link exists in bringing the product information, a procedure of displaying/clicking the notice window is omitted and the corresponding media may be immediately played. Also, In case of the product purchase, a function such as a “Buy” button on a notice window or a detailed information displaying screen is provided, so that the purchase is implemented through the click thereof. The order and settlement are implemented by using settlement information (credit card, PayPal, etc.) registered in log-in information of the document reader or additionally displaying a settlement information input window. Also, in case of a playable product such as movie, music and the like, only Preview/Trailer is show before purchase and entire music/movie can be played after purchase.

Herein, in case of the product capable of purchasing, it may be registered through Web Service API, or a service such as an internet shopping mall or a mini shop may be provided internally in the information providing server 31.

[Record, Statistics, Trend Reading Step]

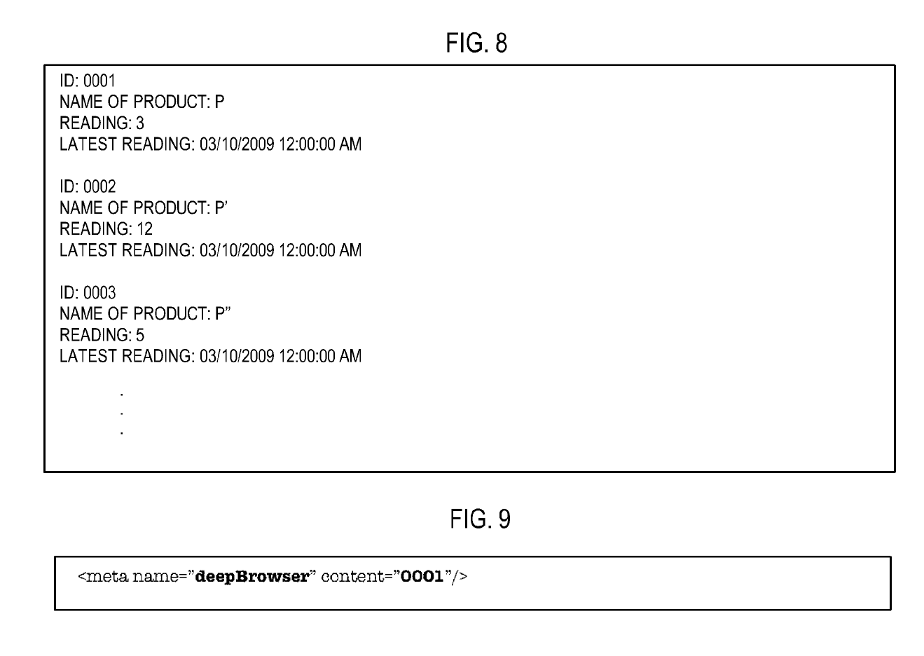

The document reader may search the product information of the document, which the document reader has been read, through contents, which are stored in the document reader information DB 36 of the information collecting server 32 in the further. Also, all of operations, which are carried out in clicking the notice window of the metadata collecting client 42 (/metadata monitoring client 41), may be identically carried out. Also, the statistics or trends for the products, which the document reader has been read, can be know (recent interest prediction). Also, the source URL of the products, which the document reader has been read, can be visited again. As the document reader operates the metadata collecting client 42 to select a “record reading function,” these functions are possible. If the document reader selects the record reading function, then the metadata collecting client 42 brings reading record (e.g., reference value, source URL, reading time, hits information, etc.) about the product, which the document reader has read, as shown in FIG. 8, from the information collecting server 32. If the document reader clicks a product desired to see again from the reading record, the summary (/detailed) information of the corresponding product are requested and transferred in the same manner with a process of requesting and transferring the product information (see FIG. 6 or/and FIG. 7) for display to the document reader.

In the meantime, the reference vale (or inclusion of summary information of the product except for the reference value is possible) of the product, which the document reader has read, is stored in the document reader information DB 36 of the information collecting server 32. Thus, since the information on the product of interest itself is recorded instead of pages, which the document reader has read, although there are difference WEB/WAP pages managing the same product, especially, different domains or networks and the providers of the respective documents are different from each other, the sources are different, but it is considered that the same information has been read. That is, an interest of the document readers may be accurately measured by collecting information with respect to subjects (products) managed in the respective WEB/WAP pages instead of WEB/WAP page itself.

Also, it may be extended to general documents, document viewer and multimedia contents such as music or movie in addition to the WEB/WAP pages and the browser. For example, in case that the metadata collecting client 42 exist in a independent application type and the metadata monitoring client 42 is embodied to be plugged in a browser and a document viewer (e.g., MS Word, PowerPoint, Acrobat, etc.), each metadata monitoring client transfers a reference value of the detected metadata to one metadata collecting client 42, which exist in an independent type. That is, although a plurality of metadata monitoring clients 41 for each viewer/player is installed on a computer of the document reader, it is required that only one metadata collecting client 42 is installed. In such a case, since only one metadata collecting client 42 exist in the computer of the document reader, all of the information to be read at the browser and other various viewers/players may be identified at one metadata collecting client 42.

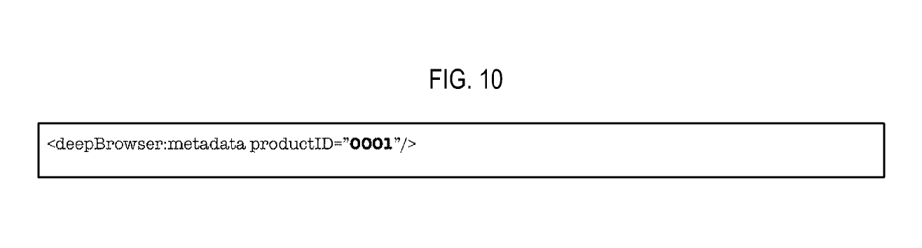

The metadata monitoring client 41 or/and the metadata collecting client 42 of the document reader may be embodied with e.g., a script for Flash/JavaFx/Silverlight, which is plug-in of the browser, and also may be embodied with plug-in of the browser. For example, there are methods embodied with Active X of IE or Plug-in or Addon of Safai or Firefox, which have a function of the metadata monitoring client 41 or “metadata monitoring client +metadata collecting client 42.” In case of using the Addon, the metadata monitoring client 41 may perform functions of detecting and reading the metadata in the WEB/WAP page by using a document object model (DOM) and the like. At this time, the metadata are inserted into a HTML document in a type as shown in FIG. 9 and FIG. 10. FIG. 9 show an example of using a meta tag, and FIG. 10 show an example of using a custom tag. The plug-in, which is an extended function to operate in the browser by using tags of <object., <embed> and the like, is operated only when a specific tag like these exit in HTML, however, Addon, which is always executed together with the browser, monitors contents read by the browser.

In case that metadata for a plurality of products is included in one document, one tag is used, wherein values are separated by using a separator or tags are attached, respectively. As an example of meta tag of HTML, the tag is inserted as <meta name=“deepBrowser” contents=“0001; 0002”/> in a former case and the tag is inserted as <meta name=“deepBrowser” contents=“0001”/>, <meta name=“deepBrowser” contents=“0002”/> in a later case.

Additionally, when metadata for a plurality of products are received from on WEB/WAP page, a screen may be complicated when notice windows are displayed for the respect products or there may be problems such as spam/abusing. Thus, the maximum number of the notice windows to be displayed on one WEB/WAP page or the maximum numbers of the notice windows to be displayed within a predetermined time may be limited. For example, the metadata collecting client 42 may memory a source URL of the metadata transferred from the metadata monitoring client 41 for a predetermined time and enables not to display when the limitation is elapsed. Also, when the metadata monitoring client 41 transfers a reference value to the metadata collecting client 42, a window displaying not only a source URL but also a source document and a handle of tap (or unique ID value internally used in other OS or browser) are transferred together, and the metadata collecting client 42 may memory these and enable not to display when the limitation is elapsed.

Also, the metadata monitoring client 41 may include some or entire functions of the metadata collecting client 42. That is, the metadata collecting client 42 may not embodied with an external application and may be possible to be integrated within the metadata monitoring client 41, i.e., flash strip or browser plug-in. Also, functions that the metadata monitoring client 41 transfers a fact of metadata detection to the metadata collecting client 42 and notifies to the user, a function of reading the detailed information, a function of checking the record and a function of reading statistics and the like may be performed in additional external application or web page.

Also, the metadata monitoring client 41 may include the metadata itself. For example, a method, which the information providing server 31 creates a swf file including a reference value of the metadata to provide the swf file itself or an object/embed tag to the document reader, may be possible. In such a case, it is not needed that the document provider 20 additionally creates the metadata. More particularly, the swf file including the corresponding reference is automatically compiled for creation when starting to write the document, or additional metadata value are inputted through the WEB/WAP pages or applications for the document provider by the document provider 20 and a swf file including the inputted values is compiled for creation. The document provider 20 may download the complied swf file to upload it to his server for use or URL of the created swf file is notified to the document provider 20 to be attached to the document.

Also, it is possible to include the detailed information itself of the product in the swf file. In such a case, there is a merit that it is not needed to bring the detailed information of the product from the information providing server 31 by the metadata collecting client 42.

Also, some functions of the information collecting server 32 may be executed locally. That is, it may be configured that functions of checking a record and reading statistics are performed in a computer of the document reader, or primarily performed in the local computer and then transferred to a remote server (information collecting server 32) at a predetermined interval or through a network (e.g., Socket). More particularly, in case that the functions such as the record check and statistics reading are performed in the computer of the document reader, the corresponding data are synchronized with the information collecting server 32, so that identical information may be shown by accessing other computers connected through the Socket.

Also, it is possible to perform functions of the metadata monitoring client 41, the metadata collecting client 42 and the information collecting server 32 in one of browser and plug-in. Also, various modifications are possible by integrating or separating other functions.

Also, the swf file may be embodied with a type including visual information such as a button, text, icon and the like.

Also, documents such as PDF, DOC, PPT and the like, images such as JPG, GIF, PNG and the like and multimedia format files such as AVI, SWF, MOV, WMV, MP3 and the like may be possible as the metadata. The metadata monitoring client 41 or “metadata monitoring client 41 and the metadata collecting client 42” may be embodied in a viewer/player corresponding to each metadata. That is, most of document, image and multimedia file formats provide metadata or an extensional function and a data space or format in which the description or information of a text type can be written. For example, Application Extension or Comment Extension exists in the GIF89a standard, also, in case of PDF, more particular metadata attachment formats such as Document Information Dictionary, Metadata Streams and the like are provided. The metadata are attached in the data space or a document using the data format.

In the above, there may be case that the metadata monitoring client 41 has to store the document reader information. This is because the information read by the document reader is not recorded when the metadata collecting client 42 is not executed. In such a case, the metadata monitoring client 41 directly transfers the metadata detection fact to the information collecting server 32. For example, the file is directly stored in the metadata monitoring client 41 or the information of the document reader is stored by using the cookie of the browser or ShareObject of Flash. Also, a unique ID issued for each metadata monitoring client 41 may be used instead of the document reader information having a security risk.

Considering a case of using the issued client ID instead of the document reader information, when a computer for common use is used, it may have a risk to store the information on the document reader due to the reason of security. Also, additionally, there may be document readers who avoid leaking their information due to hacking. In such a case, when installing the metadata monitoring client 41 or the metadata collecting client 42 or executing the clients 41 and 42, if a previously stored client ID does not exist, issue for a new client ID is request and its information is recorded for use in stead of the document reader information. Therefore, the information related to the detected metadata is not stored together with the document reader information but stored together with the client ID in the information collecting server 32. Each document reader connects the corresponding client ID with the their information through a log-in procedure (client ID is transferred together in log-in and the information collecting server 32 connects the client ID to the information of the corresponding document reader). Also, in case that the time detecting the metadata is stored together with the client ID, information in the metadata (reference value, etc.) and the like, the document reader may set such that information within a predetermined interval among information, which is detected by the metadata monitoring client 41 or the metadata collecting client 42, is connected to their information (e.g., setup in the WEB/WAP page for document reading). Additionally, an interval from log-in to log-off of the metadata collecting client or the metadata monitoring client may be automatically set as the predetermined interval

Although embodiments have been described with reference to a number of illustrative embodiments thereof, it should be understood that numerous other modifications and embodiments can be devised by those skilled in the art that will fall within the spirit and scope of the principles of this disclosure. More particularly, the variations and modifications are possible within the scope of the appended claims attached in the specification.

### INDUSTRIAL APPLICABILITY

The present invention can be applied to a network system.

1. A document search system comprising:
a client configured to detect metadata inserted into a document written by a document provider to extract a reference value, and collect information on a product based on the reference value of the metadata to provide to a document reader; and
an information providing server including or interlocked with a first DB storing product information classified by product IDs, the information providing server being configured to provide product information corresponding to a product ID indicated by the reference value to the client.

2. The document search system of claim 1, wherein the client includes:
a metadata monitoring client configured to detect metadata inserted into a document made by a document provider and extract a reference value included in the metadata; and
a metadata collecting client configured to collect information on a corresponding product based on the reference value.

3. The document search system of claim 2, further includes an information collecting server configured to collect information on a document reader reading a document containing the metadata and the reference value to store in a second DB.

4. The document search system of claim 3, wherein the metadata include the reference value indicating the product information and the reference value is a product ID.

5. The document search system of claim 4, wherein functions of collecting and providing product information of the metadata collecting client are integrated to be performed by the metadata monitoring client, and
wherein the information providing server is configured to search the first DB for a product ID indicated by the reference value (product ID) of metadata transferred from the metadata collecting client or the metadata monitoring client to transfer product information corresponding to the product ID to the metadata collecting client or the metadata monitoring client.

6. The document search system of claim 4, wherein functions of collecting and providing product information of the metadata collecting client are integrated to be performed by the metadata monitoring client,
wherein the information providing server is configured to search the first DB for a product ID indicated by the reference value (product ID) of metadata transferred from the metadata collecting client or the metadata monitoring client to transfer product information corresponding to the product ID to the information collecting server, and
wherein the information collecting server is configured to transfer the product information to the metadata collecting client or the metadata monitoring client.

7. The document search system of claim 4, wherein functions of collecting and providing product information of the metadata collecting client are integrated to be performed by the metadata monitoring client,
wherein the information collecting server is configured to transfer a reference value (product ID) of metadata transferred from the metadata collecting client or the metadata monitoring client to the information providing server, and
wherein the information providing server is configured to search the first DB for a product ID indicated by the reference value of the metadata to transfer product information corresponding to the product ID to the metadata collecting client or the metadata monitoring client.

8. The document search system of claim 4, wherein functions of collecting and providing product information of the metadata collecting client are integrated to be performed by the metadata monitoring client,
wherein the information collecting server is configured to transfer a reference value (product ID) of metadata transferred from the metadata collecting client or the metadata monitoring client to the information providing server,
wherein the information providing server is configured to search the first DB for a product ID indicated by the reference value of the metadata to transfer product information corresponding to the product ID to the information collecting server, and
wherein the information collecting server is configured to transfer the product information to the metadata collecting client or the metadata monitoring client.

9. The document search system of claim 3, wherein the metadata include the reference value indicating the product information and the reference value is a combination key in which the product ID is mapped to a document provider ID.

10. The document search system of claim 9, wherein a third DB is included in or interlocked with the information providing server, and
wherein the information providing server is configured to search the first DB for a product ID indicated by the reference value (product ID) of metadata transferred from the metadata collecting client or the metadata monitoring client to transfer product information corresponding to the product ID to the metadata collecting client or the metadata monitoring client.

11. The document search system of claim 9, wherein a third DB is included in or interlocked with the information providing server,
wherein functions of collecting and providing product information of the metadata collecting client are integrated to be performed by the metadata monitoring client,
wherein the information providing server is configured to search the third DB for a product ID corresponding to the combination key based on the reference value (combination key) of metadata transferred from the metadata collecting client or the metadata monitoring client and search the first DB for product information corresponding to the product ID to transfer to the information collecting server, and
wherein the information collecting server is configured to transfer the product information to the metadata collecting client or the metadata monitoring client.

12. The document search system of claim 9, wherein a third DB is included in or interlocked with the information providing server,
wherein functions of collecting and providing product information of the metadata collecting client are integrated to be performed by the metadata monitoring client,
wherein the information collecting server is configured to transfer a reference value (combination key) of metadata transferred from the metadata collecting client or the metadata monitoring client to the information providing server, and
wherein the information providing server is configured to search the third DB for a product ID corresponding to the combination key based on the reference value (combination key), and search the first DB for product information corresponding to the product ID to transfer to the metadata collecting client or the metadata monitoring client.

13. The document search system of claim 9, wherein a third DB is included in or interlocked with the information providing server,
wherein functions of collecting and providing product information of the metadata collecting client are integrated to be performed by the metadata monitoring client,
wherein the information collecting server is configured to transfer a reference value (combination key) of metadata transferred from the metadata collecting client or the metadata monitoring client to the information providing server,
wherein the information providing server is configured to search the third DB for a product ID corresponding to the combination key, and search the first DB for product information corresponding to the product ID to transfer to the information collecting server, and
wherein the information collecting server is configured to transfer the product information to the metadata collecting client or the metadata monitoring client.

14. The document search system of claim 9, wherein a third DB is included or interlocked with the information providing server,
wherein functions of collecting and providing product information of the metadata collecting client are integrated to be performed by the metadata monitoring client,
wherein the information collecting server is configured to search the third DB for a product ID corresponding to the combination key based on the reference value (combination key) of metadata transferred from the meta data collecting client and the metadata monitoring client to transfer to the metadata collecting client or the metadata monitoring client,
wherein the information providing server is configured to search the first DB for product information corresponding to the product ID transferred from the metadata collecting client or the metadata monitoring client to transfer to the metadata collecting client or the metadata monitoring client.

15. The document search system of claim 9, wherein a third DB is included in the information providing server or interlocked with the information providing server,
wherein functions of collecting and providing product information of the metadata collecting client are integrated to be performed by the metadata monitoring client,
wherein the information collecting server is configured to search the third DB for a product ID corresponding to the combination key based on the reference value (combination key) of the metadata transferred from the metadata collecting client or the metadata monitoring client and request product information corresponding to the product ID to the information providing server,
wherein the information providing server is configured to search the first DB for the product information corresponding to the product ID to transfer to the information collecting server, and
wherein the information collecting server is configured to transfer the product information to the metadata collecting client or the metadata monitoring client.

16. The document search system of claim 9, wherein a third DB is included in or interlocked with the information providing server,
wherein functions of collecting and providing product information of the metadata collecting client are integrated to be performed by the metadata monitoring client,
wherein the information collecting server is configured to search the third DB for a product ID corresponding to the combination key based on a reference value (combination key) of the metadata transferred from the metadata collecting client or the metadata monitoring client and request product information corresponding to the product ID to the information providing server, and
wherein the information providing server is configured to search the first DB for the product information corresponding to the product ID to transfer to the metadata collecting client or the metadata monitoring client.

17. The document search system of claim 9, wherein a third DB is included in or interlocked with the information providing server,
wherein functions of collecting and providing product information of the metadata collecting client are integrated to be performed by the metadata monitoring client,
wherein the information providing server is configured to transfer the reference value (combination key) of the metadata transferred from the metadata collecting client or the metadata monitoring client to the information collecting server,
wherein the information collecting server is configured to search the third DB for a product ID corresponding to the combination key to transfer the product ID to the information providing server, and
wherein the information providing server is configured to search the first DB for product information corresponding to the product ID to transfer to the metadata collecting client and the metadata monitoring client.

18. The document search system of claim 3, wherein the product information includes summary information or detailed information of the product and the document reader is allowable to purchase or play the corresponding product during reading the product information.

19. The document search system of claim 19, wherein the second DB further stores URL information of the document provider and document reading time information, and
wherein the metadata collecting client is configured to receive any one, some or entire combination selected from the group of a reference value of the corresponding document reader, URL information on the document provider and the document reading time information from the information collecting server in response to a request of the document reader to transfer to the document reader.

20. The document search system of claim 3, wherein the metadata monitoring client is configured to notify metadata detection with one or the combination of a notice window and sound.

21. The document search system of claim 3, wherein the metadata monitoring client is installed on a terminal of the document reader or automatically executed by a browser with being inserted into the document.

22. The document search system of claim 8, wherein the document published on Internet by a document provider by inserting metadata created based on the reference value corresponding to a specific product by searching products registered by the information provider is an evaluation document for the product including multimedia contents.

23. The document search system of claim 8, wherein the information providing server and the information collecting server are able to be integrated.

24. The document search system of claim 8, wherein the metadata monitoring client and the metadata collecting client are able to be integrated.

25.-67. (canceled)
